(19) United States
(12) Patent Application Publication
(10) Pub. No.: US 2009/0295856 A1
(43) Pub. Date: Dec. 3, 2009

(54) Method for producing printed patterns, printing apparatus, and method for printing

(75) Inventor: Masahiko Yoshida, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/455,133

(22) Filed: May 28, 2009

(30) Foreign Application Priority Data
May 30, 2008 (JP) 2008-143108

(51) Int. Cl. B41J 29/38

(52) U.S. Cl. 347/16

(57) ABSTRACT

Disclosed is a method for producing a plurality of printed patterns on a continuous medium. The method includes selecting either of a first print mode and a second print mode on the basis of a printing condition, alternately repeating an operation of printing a plurality of first images on the continuous medium located in a printing zone and printing a plurality of second images on the first images after a lapse of waiting time and an operation of transporting the continuous medium when the first print mode is selected, and alternately repeating an operation of printing the first images on the continuous medium located in a first area of the printing zone and printing the second images on the continuous medium located in a second area, downstream of the first area in the transporting direction in which the medium is transported, of the printing zone and an operation of transporting the first images printed in the first area to the second area so that the second images are printed on the first images when the second print mode is selected.

### BACKGROUND

1. Technical Field

The present invention relates to a method for producing printed patterns, a printing apparatus, and a method for printing.

2. Related Art

As for printing apparatuses for performing printing on a long medium (continuous medium) to produce many printed patterns on the medium, there is known a printing apparatus for alternately repeating a printing operation of printing a plurality of images on a medium located in a printing zone and a transporting operation of transporting a printed portion of the medium to the outside of the printing zone and transporting an unprinted portion of the medium to the printing zone. For example, JP-A-2003-118136 discloses such a printing apparatus.

In some cases, a user wants to produce printed patterns, obtained by printing different images in a superimposed manner, on a medium. In such a case, the images are blurred unless previously printed images are dried and subsequent images are then printed. The time required to dry images varies depending on a printing condition. Accordingly, if the same printing method is used independently of a printing condition, print processing time may elongate. In addition, in some cases, the user wants to perform printing suitable for a printing condition independently of drying time.

### SUMMARY

An advantage of some aspects of the invention is to perform printing using a printing method suitable for a printing condition.

An aspect of the invention provides a method for producing printed patterns on a continuous medium. The method includes selecting either of a first print mode and a second print mode on the basis of a printing condition, alternately repeating an operation of printing a plurality of first images on the continuous medium located in a printing zone and printing a plurality of second images on the first images after a lapse of waiting time and an operation of transporting the continuous medium when the first print mode is selected, and alternately repeating an operation of printing the first images on the continuous medium located in a first area of the printing zone and printing the second images on the continuous medium located in a second area, downstream of the first area in the transporting direction in which the medium is transported, of the printing zone and an operation of transporting the first images printed in the first area to the second area so that the second images are printed on the first images when the second print mode is selected.

Other features of the invention will become apparent from the following description of this specification and the accompanying drawings.

### BRIEF DESCRIPTION OF THE DRAWINGS

The invention will be described with reference to the accompanying drawings, wherein like numbers reference like elements.

FIG. 1 is a block diagram illustrating the entire structure of a printer.

FIG. 2 is a schematic diagram illustrating the entire structure of the printer.

FIG. 3 is a diagram explaining a printing zone and a portion in the vicinity thereof.

FIG. 4 is a diagram explaining a printed pattern in an embodiment of the invention.

FIG. 5 is a diagram explaining a first print mode.

FIG. 6 is a diagram explaining a second print mode.

FIGS. 7A to 7C are diagrams explaining printing data.

FIGS. 8A to 8C are diagrams illustrating the relationship among drying time and transporting times.

FIG. 9 is a flowchart of a process for selecting the print mode.

FIG. 10 is a diagram illustrating a state of calculation of a maximum amount of liquid discharged per unit area.

FIG. 11 is a diagram illustrating a state of calculation of a maximum amount of liquid discharged per unit area.

FIG. 12 is a table for determining drying time and the print mode.

FIG. 13 is a table for determining the drying time and the print mode.

FIG. 14 is a table for determining drying time and the print mode.

FIGS. 15A and 15B are diagrams illustrating other printed patterns.

FIG. 16A is a diagram illustrating another printed pattern obtained by printing three images in a superimposed manner.

FIG. 16B is a diagram illustrating printing data.

FIGS. 17A and 17B are diagrams illustrating other printed patterns.

### DESCRIPTION OF EXEMPLARY EMBODIMENTS

At least the following details will become apparent from descriptions of this specification and the accompanying drawings.

According to an aspect of the invention, there is provided a method for producing a plurality of printed patterns on a continuous medium. The method includes selecting either of a first print mode and a second print mode on the basis of a printing condition, alternately repeating an operation of printing a plurality of first images on the continuous medium located in a printing zone and printing a plurality of second images on the first images after a lapse of waiting time and an operation of transporting the continuous medium when the first print mode is selected, and alternately repeating an operation of printing the first images on the continuous medium located in a first area of the printing zone and printing the second images on the continuous medium located in a second area, downstream of the first area in the transporting direction in which the medium is transported, of the printing zone and an operation of transporting the first images printed in the first area to the second area so that the second images are printed on the first images when the second print mode is selected.

According to this method, printed patterns can be produced in an appropriate print mode. For example, printed patterns can be produced in the print mode with shorter print processing time.

In the method, preferably, in the selecting, the print mode With shorter print processing time during which a predetermined number of printed patterns are produced is selected.

According to this method, the print processing time can be reduced.

In the method, preferably, in the selecting, the waiting time is compared to the time required for the transporting operation to select the print mode with shorter print processing time during which a predetermined number of printed patterns are produced.

According to this method, the print processing time can be reduced and processing of selecting the print mode is easily performed.

In the method, it is preferable that the waiting time be determined on the basis of a maximum amount of liquid discharged per unit area of the first images.

According to this method, the print processing time can be reduced without blurring the images.

In the method, it is preferable that the waiting time be determined on the basis of the type of continuous medium.

According to this method, the print processing time can be reduced without blurring the images.

In the method, it is preferable that the waiting time be determined on the basis of the type of liquid used for printing the first images.

According to this method, the print processing time can be reduced without blurring the images.

In the method, preferably, the waiting time is determined on the basis of whether or not to use a drying unit that dries the printed patterns while supporting the continuous medium in the printing zone.

According to this method, the print processing time can be reduced without blurring the images.

According to another aspect of the invention, there is provided a printing apparatus including a head that discharges liquid to a continuous medium, a transporting mechanism that transports the continuous medium to a printing zone, and a control unit that controls producing of a plurality of printed patterns on the continuous medium. The control unit selects either of a first print mode and a second print mode on the basis of a printing condition. In the first print mode, an operation of printing a plurality of first images on the continuous medium located in the printing zone and printing a plurality of second images on the first images after a lapse of waiting time and an operation of transporting the continuous medium are alternately repeated. In the second print mode, an operation of printing the first images on the continuous medium located in a first area of the printing zone and printing the second images on the continuous medium located in a second area, downstream of the first area in the transporting direction in which the medium is transported, of the printing zone and an operation of transporting the first images printed in the first area to the second area so that the second images are printed on the first images are alternately repeated.

According to the printing apparatus, printed patterns can be produced in an appropriate print mode. For example, printed patterns can be produced in the print mode with shorter print processing time.

### Printer

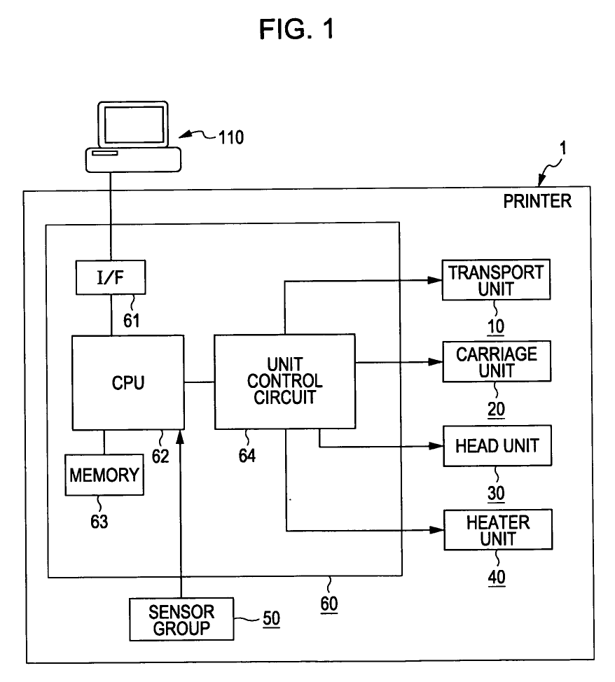

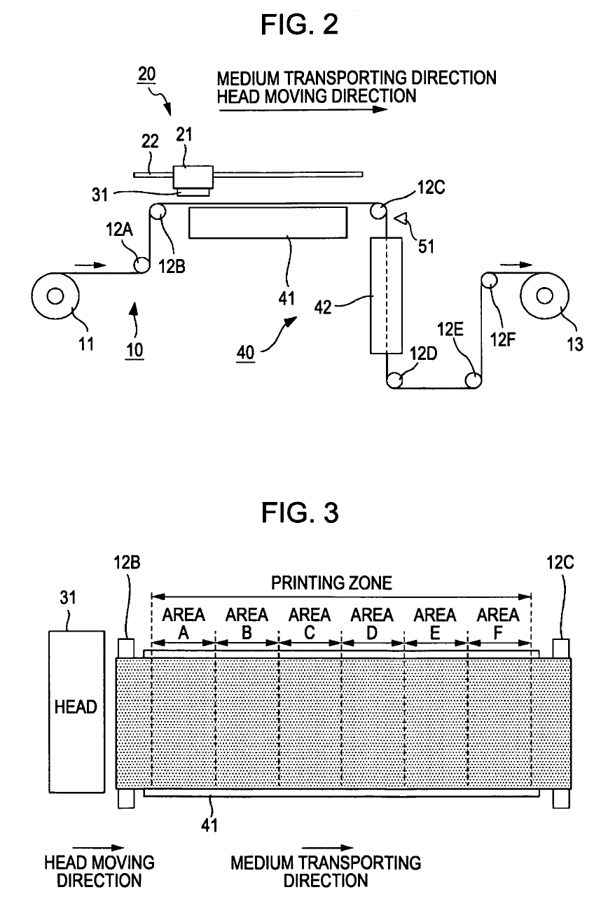

FIG. 1 is a block diagram illustrating the entire structure of a printer 1 according to an embodiment of the invention. FIG. 2 is a schematic diagram illustrating the entire structure of the printer 1. FIG. 3 is a diagram explaining a printing zone and a portion in the vicinity of the zone. The fundamental structure of the printer 1 according to the embodiment will be described below.

The printer 1 includes a transport unit 10, a carriage unit 20, a head unit 30, a heater unit 40, a sensor group 50, and a controller 60. When receiving printing data from a computer 110 as en external apparatus, the printer 1 allows the controller 60 to control the respective units, i.e., the transport unit 10, the carriage unit 20, the head unit 30, and the heater unit 40. The controller 60 controls the respective units on the basis of the printing data supplied from the computer 110, thus printing an image on a sheet of paper. The sensor group 50 monitors a state in the printer 1 and outputs data indicating a result of detection to the controller 60. The controller 60 controls the units on the basis of the detection result output from the sensor group 50.

The transport unit (transport mechanism) 10 transports a rolled medium (corresponding to a continuous medium, such as a roll sheet or a roll label) in a predetermined direction (hereinafter, referred to as “transporting direction”). The transport unit 10 includes a feed mechanism 11, transport rollers 12A to 12F, and a take-up mechanism 13. The transport rollers 12A and 12B transport the medium fed by the feed mechanism 11 to a printing zone and also transport the medium printed in the printing zone to the take-up mechanism 13. The controller 60 controls a transport motor (not shown) to regulate the amount of rotation of each of the transport rollers 12A to 12F, thus controlling the amount of transport of the medium.

The carriage unit 20 moves a head in a moving direction. The carriage unit 20 includes a carriage 21 that moves in a predetermined direction (the moving direction) and a guide 22 that guides the carriage 21 in the moving direction. The controller 60 controls a carriage motor (not illustrated), thereby controlling movement of the carriage 21. In the printer 1 according to the embodiment, the moving direction in which the carriage 21 moves is the same as the transporting direction in which the transport unit 10 transports the medium.

The head unit 30 includes the head, indicated at 31, discharging ink (liquid) to a sheet of paper. The head 31 is mounted on the carriage 21. When the carriage 21 moves in the moving direction, therefore, the head 31 also moves in the moving direction. The head 31 has on the lower surface thereof arrays of nozzles arranged in the widthwise direction of the medium. The nozzles are disposed in a range corresponding to the width of the medium. The head 31 discharges ink while moving in the moving direction, so that the medium is subjected to printing in the printing zone.

The head 31 has on the lower surface thereof the arrays of nozzles (not illustrated) discharging inks of different colors, e.g., cyan, magenta, yellow, and black. The head 31 further includes on the lower surface thereof an array of nozzles discharging white ink, an array of nozzles discharging a fixing agent, and an array of nozzles discharging a coating agent.

The heater unit 40 includes a hot platen 41 and a dry mechanism 42. The hot platen 41 supports the medium in the printing zone and includes a heater (corresponding to a dry unit). The hot platen 41 heats the medium located in the printing zone to accelerate drying of printed images in the printing zone. The dry mechanism 42 is placed downstream of the printing zone. The dry mechanism 42 heats the medium subjected to printing in the printing zone to accelerate drying of printed patterns on the outside of the printing zone. A maximum heating range of the dry mechanism 42 corresponds to the printing zone or greater. The heating range of the dry mechanism 42 can be changed by the controller 60. For example, printed patterns can be heated in a range corresponding to three areas (e.g., areas A to C in FIG. 3). Accordingly, power consumed by the dry mechanism 42 heating a portion corresponding to three areas is less than that by the dry mechanism 42 heating a portion corresponding to the printing zone (six areas in FIG. 3). As for each of the hot platen 41 and the dry mechanism 42, any device can be used so long as the device can dry printed images or printed patterns on the medium. For example, a device for applying warm air, infrared rays, ultraviolet (UV) rays, or a magnetic wave, such as a microwave, to the medium may be used.

The sensor group 50 includes, for example, a mark sensor 51. The mark sensor 51 is used to detect a mark printed on the medium. The amount of the medium transported by the transport unit 10 is controlled on the basis of the result of detection by the mark sensor 51. The sensor group 50 includes encoders for detecting the amounts of rotation by the transport rollers 12A to 12F and a linear encoder for detecting the position of the carriage 21 in the moving direction.

The controller 60 is a controlling unit (control section) for controlling the printer 1. The controller 60 includes an interface unit 61, a CPU 62, a memory 63, and a unit control circuit 64. The interface unit 61 permits transfer of data between the printer 1 and the computer 110 serving as the external apparatus. The CPU 62 serves as an arithmetic processing unit for controlling the entire printer 1. The memory 63 is used to ensure an area for storing a program for the CPU 62 and a working area. In addition, the memory 63 stores image data of an image to be printed. The CPU 62 controls the respective units through the unit control circuit 64 in accordance with the program stored in the memory 63 to execute a printing process which will be described later. In addition, the CPU 62 allows the head 31 to discharge the inks from the nozzles (not illustrated) in the head 31 in accordance with the image data stored in the memory 63, thus printing the image based on the image data on the medium.

When the printing process is executed, the printer 1 alternately repeats a transporting operation of transporting the medium in the transporting direction through the transport unit 10 and a printing operation of discharging the inks from the head 31 on the basis of image data to print images on the medium while moving the head 31 through the carriage unit 20, thereby producing printed patterns at regular intervals on the medium.

In the following description, it is assumed that the printing zone is divided into six areas, as shown in FIG. 3, and an image is printed in each area. The six areas include the area A, the area B, the area C, an area D, an area E, and an area F in order from upstream to downstream in the transporting direction (see FIG. 3). A printed pattern in each area is obtained by printing a plurality of images in such a superimposed manner that one image is superimposed on another. The number of divided areas is not limited to six. In addition, the size of the printing zone can be changed depending on the size of a printed pattern. The size of the printing zone is not necessarily set to a maximum printable range (corresponding to a range in which the carriage 21 is movable) of the printer 1.

### Print Modes

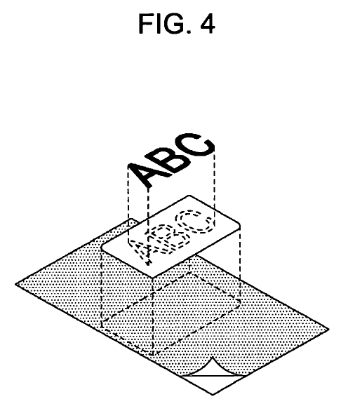

FIG. 4 is a diagram explaining a printed pattern in the embodiment. In the embodiment, it is assumed that a printed pattern is produced by printing a plurality of images in a superimposed manner. An image first printed on the medium is a rectangular image (hereinafter, referred to as “white image” corresponding to a first image) formed by applying the white ink to the medium. An image printed so as to be superimposed on the white image is an image of characters “ABC” (hereinafter, referred to as “ABC image” corresponding to a second image). In other words, the printed pattern is obtained by forming a first layer corresponding to the white image and a second layer corresponding to the ABC image on the medium in a superimposed manner.

Referring to FIG. 4, the medium is composed of a label member (base) in which one surface is to be printed and the other surface is adhesive, and a peelable member that covers the adhesive surface of the label member. The label member includes a transparent film. However, the label member is not necessarily transparent. A translucent member or an opaque member may be used. In addition, the medium does not necessarily include a label sheet. The medium may include a transparent film having no adhesive surface or a sheet of paper.

The printed pattern obtained by printing a plurality of images in a superimposed manner is not limited to that in the embodiment. A character image may be superimposed on a figure image. A background image to be printed on a transparent film is not limited to a white image. The shape of the white image, serving as a background image, is not limited to a rectangle. In addition, an underlying image or a coating image may be formed in order to improve the ink absorbability, luster, and/or water resistance of the medium. Furthermore, a UV ink image may be formed using UV ink.

In the case where a plurality of images are printed in a superimposed manner as described above, if the ABC image is printed before the first printed white image is dried, the ABC image is blurred. Accidentally, a printed pattern with poor image quality is produced. In the embodiment, therefore, time for drying the white image is provided between the time when the white image is printed and the time when the ABC image is printed on the white image.

In the embodiment, the printer 1 performs printing in any one of a plurality of print modes (first print mode and second print mode). The computer 110 selects either of the first and second print modes on the basis of a “printing condition” in accordance with a printer driver installed in the computer 110. The first print mode and the second print mode will now be described below.

### First Print Mode

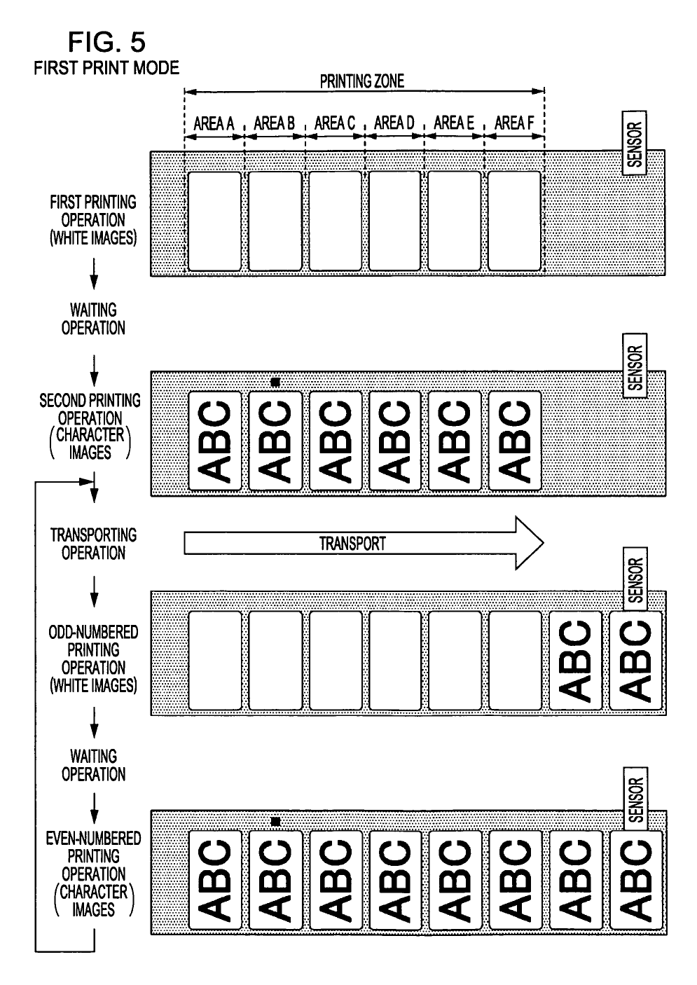

FIG. 5 is a diagram explaining the first print mode. In the first print mode, the printer 1 prints six “white images” on the medium in the areas A to F of the printing zone while moving the head 31 in the moving direction during a first printing operation. The printer 1 then waits for a predetermined period of time until the white images printed on the medium are dried (waiting operation). After that, the printer 1 prints six “ABC images” on the medium in the areas A to F while moving the head 31 in the moving direction during a second printing operation. Consequently, the ABC images are printed so as to be superimposed on the white images, respectively, so that six printed patterns, as shown in FIG. 4, are formed on the medium. During the second printing operation, a mark used for a transporting operation is also printed in the area B.

After the second printing operation, the printer 1 transports the medium by an amount corresponding to the length of a portion, where the six printed patterns are arranged, of the medium. It is assumed that when the medium is transported until the mark printed in the area B is detected by the sensor, it is determined that the transporting operation of transporting the medium by the amount corresponding to the length of the portion including the six printed patterns has been done. An unprinted portion of the medium is transported to the printing zone in this “transporting operation” and images are printed in the printing operations.

In summary, in the first print mode, the printer 1 prints six white images (first images) on the medium in the respective areas A to F of the printing zone during the odd-numbered printing operation (e.g., the first printing operation), dries the white images during the waiting operation, and after that (i.e., after the waiting time), prints the six ABC images (second images) on the medium in the respective areas A to F of the printing zone during the even-numbered printing operation (e.g., the second printing operation). Consequently, the six printed patterns, as shown in FIG. 4, are formed on the medium. In this instance, the odd-numbered printing operation, the waiting operation, and the even-numbered printing operation are combined into an “image forming operation”. The printer 1 transports the medium by the amount corresponding to the length of the portion including the six printed patterns as the “transporting operation (corresponding to an operation of transporting)” and transports an unprinted portion of the medium to the printing zone, and performs the “image forming operation” on the unprinted portion of the medium. The printer 1 alternately repeats the “image forming operation” and the “transporting operation” so that six printed patterns are formed in each image forming operation. Thus, many printed patterns are formed (produced) at regular intervals on the medium.

### Second Print Mode

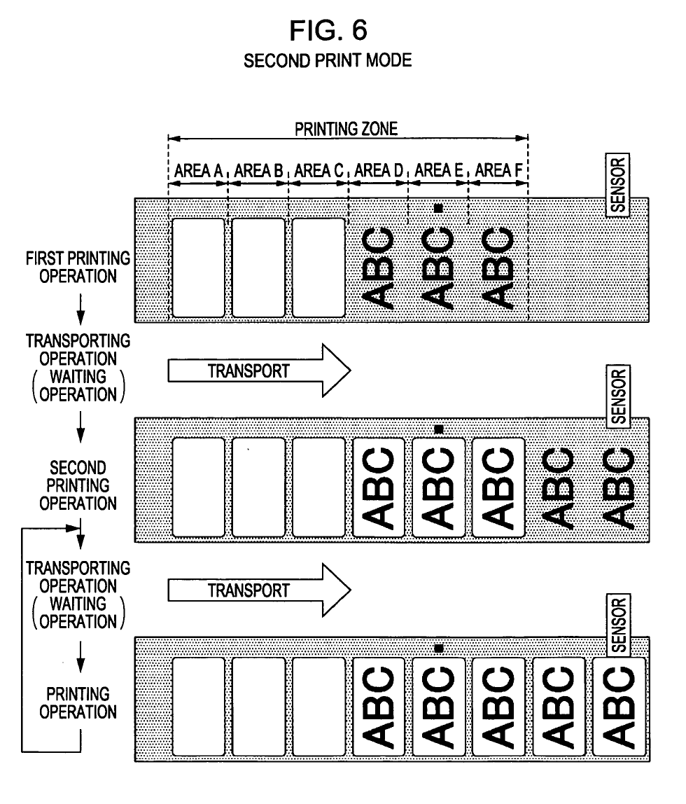

FIG. 6 is a diagram explaining the second print mode. In the second print mode, during the first printing operation, the printer 1 prints “white images” on the medium in the respective areas A to C of the printing zone while moving the head 31 in the moving direction, and also prints “ABC images” on the medium in the areas D to F downstream of the areas A to C in the transporting direction. A mark used for the transporting operation is printed in the area E.

After the first printing operation, the printer 1 transports the medium by an amount corresponding to a portion, where three printed patterns are arranged, of the medium as the “transporting operation”. It is assumed that when the medium is transported until the sensor detects the mark printed in the area E in the above-described first printing operation, it is determined that the transporting operation of transporting the medium by the amount corresponding to the length of the portion including three printed patterns has been done. In this transporting operation, the white images printed in the areas A to C during the first printing operation are transported to the areas D to F and an unprinted portion of the medium is transported to the areas A to C.

During the second printing operation after the transporting operation, the printer 1 prints white images on the medium in the areas A to C, ABC images on the medium in the areas D to F, and a mark in the area E in a manner similar to the first printing operation. Consequently, during the second printing operation, the ABC images are printed on the white images, which have been printed during the first printing operation, in the areas D to F. Thus, the three printed patterns (see FIG. 4) are formed. In the second print mode, the printer 1 alternately repeats the “printing operation” and the “transporting operation”.

In the first print mode, white images are printed, time for drying the white images is provided, and after that, ABC images are printed so as to be superimposed on the white images. On the other hand, in the second print mode, white images are printed in the areas A to C and the white images are dried while the white images are transported to the areas D to F. Specifically, if time (waiting operation) only for drying white images as in the first print mode is not provided, the images are prevented from being blurred in the second print mode. In other words, the transporting operation also functions as the waiting operation, during which white images are dried, in the second print mode. Time (hereinafter, “transporting time”) during which the medium is transported by the amount corresponding to the length of a portion including three printed patterns is equal to or greater than the drying time for white images.

In summary, in the second print mode, the printer 1 prints three white images (first images) on the medium in the areas A to C (first area), respectively, and also prints three ABC images (second images) on the medium in the areas D to F (second area), respectively, during the “printing operation”. During the “transporting operation (corresponding to an operation of transporting)”, the printer 1 transports the medium by the amount corresponding to the length of a portion including three printed patterns. The printer 1 alternately repeats the “printing operation” and the “transporting operation” so that three printed patterns are formed in each printing operation. Thus, many printed patterns are formed (produced) at regular intervals on the medium.

In the printer 1, the printed patterns on the medium are transported to the outside of the printing zone, the printed patterns are dried by the dry mechanism 42 shown in FIG. 2, and after that, the portion, including the dried printed patterns, of the medium is wound by the take-up mechanism 13. Since the medium is wound after the ABC images printed on the white images are dried, the medium is prevented from being smeared. In the first print mode, six printed patterns are transported to the outside of the printing zone in one transporting operation. In the second print mode, three printed patterns are transported to the outside of the printing zone in one transporting operation. Accordingly, it is necessary in the first print mode that the dry mechanism 42 heats a portion, including six printed patterns, of the medium. In the second print mode, it is sufficient that the dry mechanism 42 heats a portion, including three printed patterns, of the medium. Therefore, the amount of power consumed in the second print mode is lower than that in the first print mode.

### Printing Data in Respective Print Modes

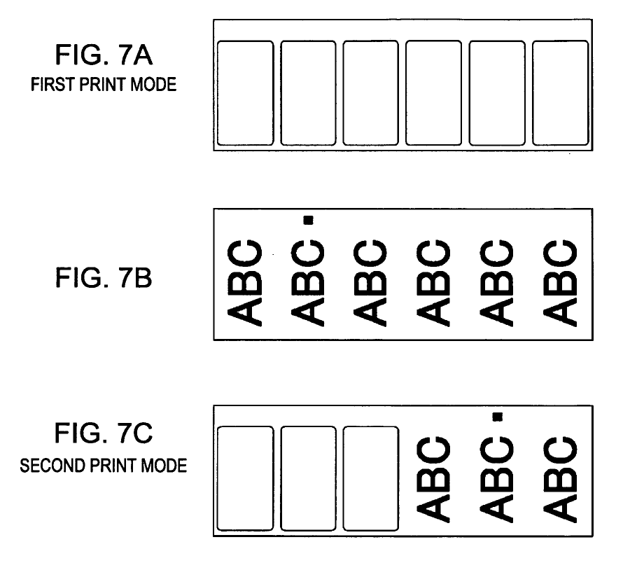

FIGS. 7A and 7B are diagrams explaining printing data for producing printed patterns in the first print mode. FIG. 7A illustrates printing data for the odd-numbered printing operation. FIG. 7B illustrates printing data for the even-numbered printing operation. The printing data for the odd-numbered printing operation includes six white images to be printed in the areas A to F. The printing data for the even-numbered printing operation includes six ABC images to be printed in the areas A to F and a mark to be printed in the area B. In the first print mode, images to be printed during the odd-numbered printing operation differ from those during the even-numbered printing operation. Accordingly, the computer 110 generates printing data. After that, the computer 110 has to allow a memory to store two kinds of printing data.

FIG. 7C is a diagram explaining printing data for producing printed patterns in the second print mode. The printing data for the second print mode includes three white images to be printed in the areas A to C, three ABC images to be printed in the areas D to F, and a mark to be printed in the area E. Since the same images to be printed are used during each printing operation in the second print mode, the computer 110 may allow the memory to store one kind of printing data. Therefore, the used memory capacity in the second print mode can be less than that in the first print mode.

### Print Processing Times of Print Modes

Print processing times of the respective print modes will be described below. As described above, the amount (the length of a portion corresponding to three printed pattern) of the medium transported during one transporting operation in the second print mode is less than that (the length of a portion corresponding to six printed patterns in the medium) in the first print mode. In the following description, therefore, it is assumed that transporting time tc in the second print mode is less than transporting time Tc in the first print mode (tc<Tc). In addition, it is assumed that drying time Td (time for the waiting operation), required between the time when white images are printed and the time when ABC images are printed in the first print mode is equal to that in the second print mode. Furthermore, since six images are printed during one printing operation in each of the first print mode (during each of the odd-numbered operations and the even-numbered operations in the first print mode) and the second print mode, it is assumed that printing time Tp required for one printing operation in the first print mode is equal to that in the second print mode.

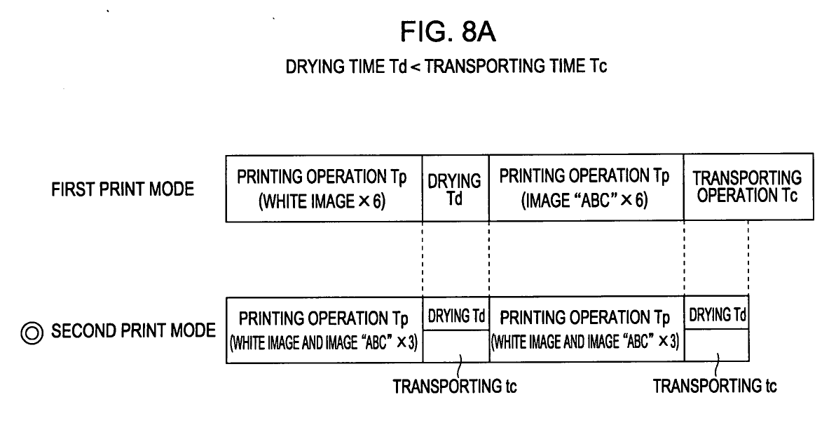

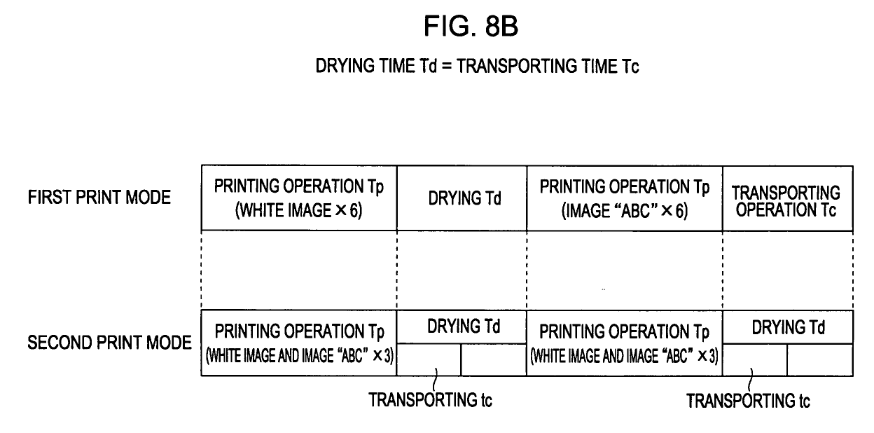

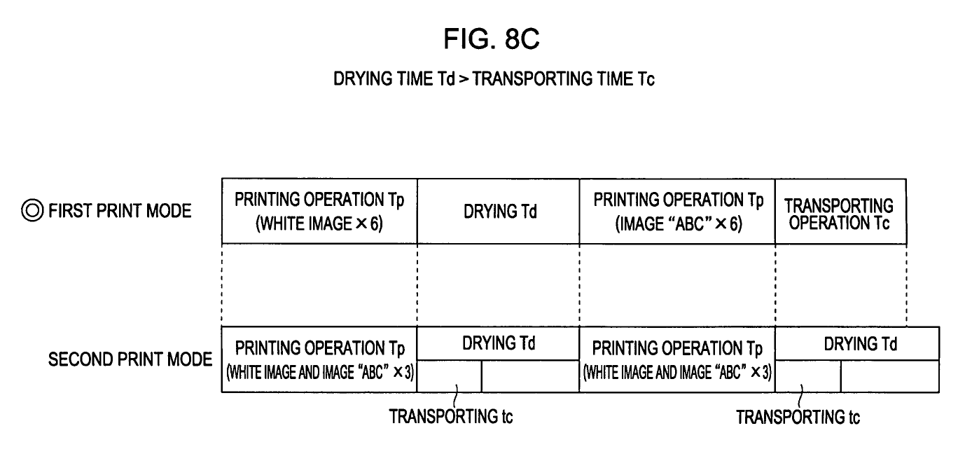

FIG. 8A is a diagram explaining print processing times when the drying time Td is less than the transporting time Tc in the first print mode (Td<Tc). FIG. 8A illustrates the print processing times each required to produce six printed patterns. The transporting time tc in the second print mode is less than the transporting time Tc in the first print mode and is substantially equal to the drying time Td. Accordingly, the print processing time of the first print mode is obtained by adding the length of time for two printing operations (2Tp), one drying time Td, and one transporting time Tc (2Tp+Td+Tc). The print processing time of the second print mode is obtained by adding the length of time for two printing operations (2Tp) and two drying times 2Td (2Tp+2Td). Referring to FIG. 8A, the drying time Td is less than the transporting time Tc in the first print mode. Accordingly, the print processing time of the second print mode can be less than that in the first print mode by an amount corresponding to the difference between the transporting time Tc in the first print mode and the drying time Td. Consequently, many printed patterns can be produced in shorter time in the second print mode. In other words, the transporting time tc in the second print mode is substantially equal to the drying time Td in FIG. 8A, and white images can be dried during the transporting operation in the second print mode. Although the first print mode needs time only for drying white image, the second print mode does not include the time only for drying white images. Thus, the print processing time of the second print mode can be reduced.

In the case where the drying time Td is less than the transporting time Tc in the first print mode, if the difference between the transporting time Tc in the first print mode and the transporting time tc in the second print mode is small and the transporting time tc in the second print mode is greater than the drying time Td (this relationship is not illustrated), the print processing time of the first mode may be less than that of the second print mode. In other words, the print processing times of the respective print modes depend on the relationship among the drying time and the transporting times. When the transporting time tc in the second print mode is substantially half of the transporting time Tc in the first print mode and the drying time Td is less than the transporting time Tc in the first print mode, the print processing time of the second print mode is less than that of the first print mode. In the following description, therefore, it is assumed that the transporting time tc in the second print mode is substantially half of the transporting time Tc in the first print mode.

FIG. 8B is a diagram explaining print processing times when the drying time Td is equal to the transporting time Tc in the first print mode (Td=Tc). In this case, print processing time of the first print mode is equal to that of the second print mode as shown in the figure. Accordingly, the same print processing time is required to produce printed patterns in any of the print modes.

FIG. 8C is a diagram explaining print processing times when the drying time Td is greater than the transporting time Tc in the first print mode. In this case, this first print mode needs only one period corresponding to the drying time Td which is greater than the transporting time Tc. Whereas, the second print mode needs two periods each corresponding to the drying time Td which is greater than the transporting time tc. When the drying time Td is greater than the transporting time Tc in the first print mode, it is difficult to dry white images only during the transporting operation in the second print mode. Long time for drying white images has to be provided after the transporting operation. Unfortunately, the print processing time of the second print mode is greater than that in the first print mode by an amount corresponding to the difference between the drying time Td and the transporting time Tc in the first print mode.

In summary, since the number of images printed during one printing operation in the first print mode is equal to that in the second print mode, printing time for one printing operation in the first print mode is substantially equal to that in the second print mode. Accordingly, the print mode with shorter print processing time is changed depending on the relationship among the drying time Td during which first printed images (white images) are dried and the transporting times Tc and tc. Therefore, when printing is performed in either of the print modes (printing methods) irrespective of the drying time Td and the transporting times Tc and tc, print processing time may elongate.

An advantage of some aspects of the embodiment of the invention is that print processing time for producing printed patterns obtained by printing a plurality of images in a superimposed manner is shortened as much as possible.

### Method for Selecting Print Mode

### Overview of Method for Selecting Print Mode

The print mode with shorter print processing time is changed between the first print mode and the second print mode depending on the relationship among the drying time Td during which first printed images are dried and the transporting times Tc and tc. In this embodiment, the computer 110 selects the print mode with shorter print processing time from the first and second print modes on the basis of the drying time Td and the transporting times Tc and tc in accordance with the printer driver that generates printing data. The drying time Td and the transporting times Tc and tc are determined on the basis of a printing condition for printed patterns to be produced. In other words, therefore, the computer 110 selects either of the first and second print modes on the basis of a “printing condition” for printed patterns. The printer 1 produces printed patterns in the print mode selected by the computer 110. Thus, the print processing time for producing printed patterns obtained by printing a plurality of images in a superimposed manner can be shortened as much as possible. It is not necessarily that the computer 110 selects the print mode. When printed patterns are produced by a printer alone instead of by a printing system including a computer and a printer connected to the computer as in the embodiment, the controller (control section) 60 in the printer 1 may select the print mode.

For example, it is assumed that printed patterns including two superimposed images as shown in FIG. 4 are produced and the relationships among the drying time Td and the transporting times Tc and tc as shown in FIGS. 8A to 8C are established. In this case, when the drying time Td during which first printed images are dried is less than the transporting time tc in the first print mode, the computer 110 selects the first print mode (FIG. 8A). On the other hand, when the transporting time Tc in the first print mode is less than the drying time Td, the computer 110 selects the second print mode (FIG. 8C). Consequently, the printer 1 produces printed patterns in the print mode with shorter print processing time, so that the total print processing time can be reduced.

If the drying time Td is equal to the transporting time Tc in the first print mode, the computer 110 may select any of the modes. For example, as shown in FIGS. 7A to 7C, although two kinds of image data have to be stored in the memory in the first print mode, one kind of image data may be stored in the memory in the second print mode. Accordingly, the second print mode may be selected. Furthermore, in the use of the hot platen 41 and the dry mechanism 42 after printing, the first print mode needs heater capacity for drying six white images. In the second print mode, however, the heater capacity for drying three white images prevents images from blurring. Accordingly, the second print mode may be selected.

If the computer 110 previously stores the established relationships among the drying time Td and the transporting times Tc and tc as shown in FIG. 8A to 8C, the computer 110 compares the drying time Td for drying first printed images with the transporting time Tc in the first print mode, so that the computer 110 can select either of the print modes. The method for selecting the print mode is not limited to this case. For example, when the time Tp required for one printing operation in the first print mode differs from that in the second print mode, the computer 110 may actually calculate the print processing time of the first print mode and that of the second print mode on the basis of the printing time and transporting time in each print mode and the drying time for drying images and compare the calculated print processing times. Thus, the print mode with shorter print processing time can be reliably selected.

In summary, before producing printed patterns obtained by printing a plurality of images (first images and second images) in a superimposed manner, the computer 110 (corresponding to the control section) in the embodiment selects either of the first and second print modes on the basis of a printing condition and produces a plurality of printed patterns on a medium (continuous medium) in the selected print mode. The computer 110 selects the print mode with shorter print processing time required to produce a predetermined number of printed patterns. Consequently, when printing is performed in the first print mode, first printed images are dried during the waiting operation. When printing is performed in the second print mode, first printed images are dried during the transporting operation. Thus, the images are prevented from being blurred and the print processing time is reduced.

The print processing time of each of the first and second print modes is affected by the printing time Tp in one printing operation, the drying time Td for first printed images (white images), and the transporting time Tc or tc in one transporting operation as shown in FIGS. 8A to 8C. Accordingly, those time periods are added for each print mode. The print processing time of the first print mode and that of the second print mode are calculated and compared, so that the print mode with shorter print processing time can be selected.

In any of the print modes, printing is performed over a region corresponding to the same number of images (in this case, six images), namely, the same printing zone (including the areas A to F). In some printers, therefore, the printing time Tp for one printing operation in the first print mode is equal to that in the second print mode. In such a printer, the print mode with shorter print processing time can be selected by comparing the drying time Td (waiting time) for first printed images with the transporting times Tc and tc as shown in FIGS. 8A to 8C, namely, on the basis of the drying time Td and the transporting times Tc and tc. Accordingly, when the memory of the computer 110 is allowed to store the relationship between each result of comparison among the drying time Td and the transporting times Tc and tc and the suitable print mode, the computer 110 can reduce processing time required to select the print mode.

In the embodiment, the drying time Td is compared to the transporting time Tc in the first print mode (refer to FIGS. 8A to 8C), so that the print mode with shorter print processing time can be selected. The print mode can be determined irrespective of the transporting time tc in the second print mode. Consequently, processing time required to select the print mode can be further reduced. Establishing the relationship in FIG. 8A requires the condition that the transporting time Tc in the first print mode is less than (substantially half of) the transporting time tc in the second print mode. Under the condition, the drying time Td is substantially equal to the transporting time tc in the second print mode, so that the print processing time of the second print mode is less than that of the first print mode. The relationship between the transporting time Tc in the first print mode and the transporting time tc in the second print mode varies depending on the number of images printed in a superimposed manner (two images in this embodiment) or the mechanism of the printer. Accordingly, when the relationships as shown in FIGS. 8A to 8C are previously obtained in accordance with the conditions, e.g., the number of images printed in a superimposed manner and the printer mechanism, and the computer 110 is allowed to store the obtained relationships, the print mode can be selected on the basis of the result of comparison between the drying time Td and the transporting time Tc in the first print mode. The processing time required to select the print mode can be further reduced.

First to fifth examples of how to select the print mode will be described below. In the first to fifth examples, for convenience of explanation, it is assumed that a printed pattern including two images (one white image and one ABC image) printed in a superimposed manner is produced and the relationships among the drying time Td and the transporting times Tc and tc as shown in FIGS. 8A to 8C are established.

### FIRST EXAMPLE OF SELECTING PRINT MODE

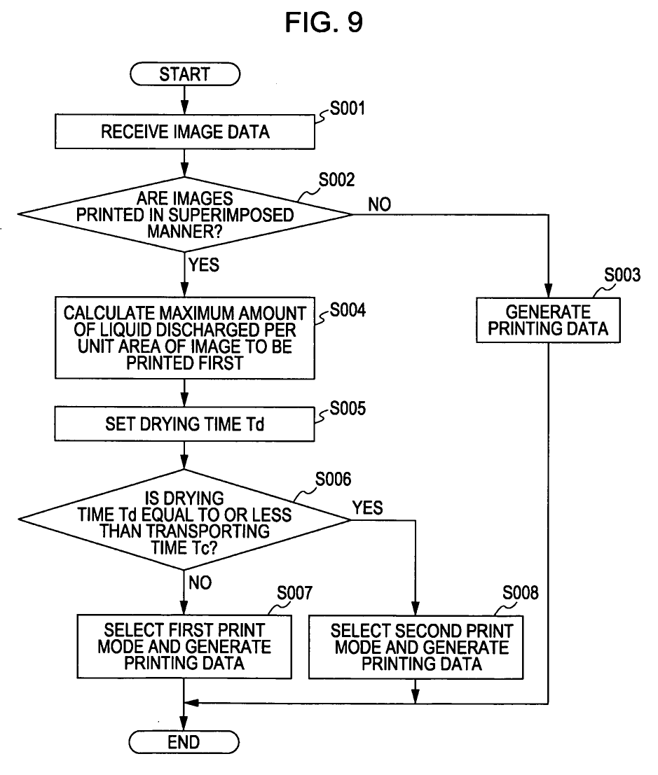

FIG. 9 is a flowchart of a process for selecting the print mode by the computer 110. First, when the computer 110 receives image data of patterns to be printed from application software (step S001), the computer 110 determines whether images are printed in a superimposed manner to produce the printed patterns (step S002). If the images are not printed in a superimposed manner (NO in step S002), printing data (not shown) is generated so that an operation of printing images at regular intervals in a printing zone on a medium and an operation of transporting the medium are alternately repeated. Whereas, when the images are printed in a superimposed manner, the computer 110 selects either of the first print mode and the second print mode.

Each of the transporting times Tc and tc in the respective print modes is determined on the basis of an amount of the medium transported during one transporting operation. In the case where two different images are printed in a superimposed manner to produce a printed pattern shown in FIG. 4, therefore, the transport amount in the first print mode corresponds to the length of a portion, where six printed patterns are arranged, of the medium, and that in the second print mode corresponds to the length of a portion, where three printed patterns are arranged, of the medium. The transporting times Tc and tc are determined on the basis of the above-described transport amounts. In other words, the transport amount is determined on the basis of the number of images superimposed to produce a printed pattern or the size of an image. Accordingly, each of the transporting times Tc and tc is determined by a printed pattern to be produced. Although the transporting time varies depending on transporting speed of a medium transport mechanism, the transporting time is determined by a printed pattern to be produced so long as the transporting speed is constant.

On the other hand, the drying time Td varies depending on various printing conditions. When generating printing data, therefore, the computer 110 determines the drying time Td on the basis of any or all of various printing conditions affecting the drying time Td. Consequently, the computer 110 can compare the drying time Td for first printed images with the transporting time Tc in the first print mode, thus selecting the print mode with shorter print processing time on the basis of the relationships (shown in FIGS. 8A to 8C) between the drying time Td and the transporting time Tc.

Generally, the larger the amount of liquid discharged to the medium, the longer the time required to dry the liquid. In the first example, therefore, the computer 110 sets the drying time Td so that the drying time Td becomes longer as the amount of liquid discharged to the medium becomes larger. In other words, in the first example, the drying time Td is determined on the basis of the amount of liquid discharged to the medium (the density of an image), and the print mode with shorter print processing time is then selected. Referring to the flowchart of FIG. 9, when the images are printed in a superimposed manner (YES in step S002), a maximum amount of liquid discharged per unit area of an image to be first printed is calculated (step S004).

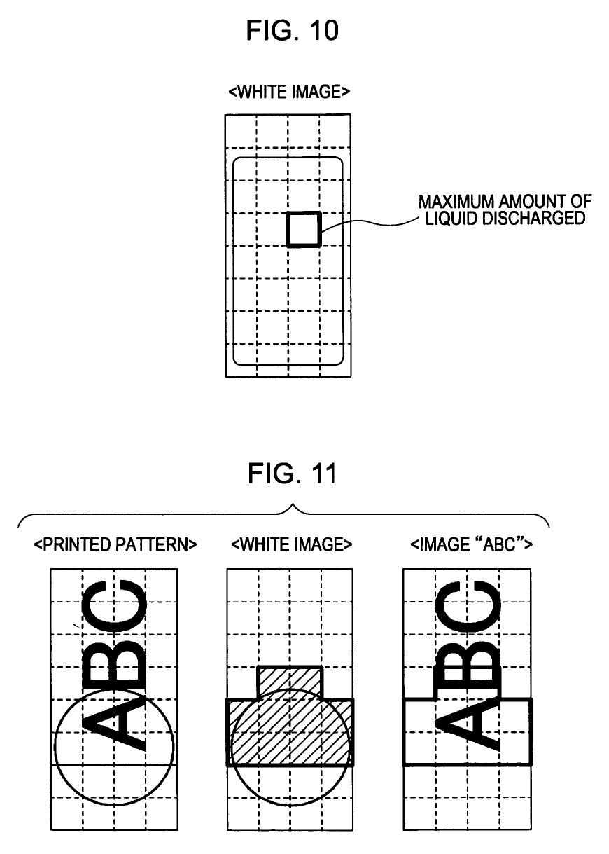

FIG. 10 is a diagram illustrating a state of calculation of a maximum amount of liquid discharged per unit area. Since a white image corresponds to image data for first printing in the embodiment, the maximum amount of liquid discharged per unit area of the white image is calculated. Referring to FIG. 10, the image data corresponding to the white image is divided into a plurality of unit areas (e.g., 16 pixels×16 pixels). Each small square in FIG. 10 represents a unit area. The amount of liquid discharged to each unit area is calculated. Referring to FIG. 10, there are unit areas where white ink is not discharged, unit areas partially applied with the white ink, and unit areas entirely applied with the white ink. The maximum amount of liquid discharged among the amounts of liquid discharged to the respective unit areas is determined. After that, the computer 110 determines the drying time Td for the first printed images on the basis of the maximum amount of liquid discharged per unit area (step S005).

When the drying time Td is equal to or less than the transporting time Tc in the first print mode (YES in step S006), it is determined in step S008, on the basis of the relationships between the drying time Td and the transporting time Tc shown in FIGS. 8A to 8C, that the second print mode should be selected. The computer 110 generates printing data for printing in the second print mode. Whereas, when the drying time Td is greater than the transporting time Tc in the first print mode (NO in step S006), it is determined in step S007 that the first print mode should be selected. The computer 110 generates printing data for printing in the first print mode.

In the first example, the computer 110 sets the length of the drying time Td on the basis of the maximum amount of liquid discharged per unit area of the image to be first printed and compares the drying time Td with the transporting time Tc in the first print mode, thus selecting either of the print modes. Consequently, the print processing time can be reduced without blurring the images.

As for the amount of liquid discharged per unit area, for example, an amount of white ink discharged for image data corresponding to the entire white image may be obtained. As shown in FIG. 10, however, it is preferred that image data for the white image be divided into small unit areas and the drying time and the print mode be selected on the basis of the amount of white ink discharged per small unit area. The reason is as follows: If the white image serves as a background for the ABC image, the amount of white ink discharged is uniform in the entire image. In some cases, however, liquid is discharged to part of an image. In comparison of an image printed by uniformly applying liquid to the whole of a region corresponding to the image with an image printed by applying liquid to part of a region corresponding to the image, assuming that those images use the same amount of liquid discharged for the entire image data, the image printed by applying liquid to part of the region requires longer time until the image is dried. Accordingly, if the drying time is determined on the basis of the amount of liquid discharged for the entire image data, a second image may be printed before the first image printed by applying liquid to part of the region is not dried, alternatively, the drying time for the image printed by uniformly applying liquid to the region may be set long unnecessarily. Therefore, the computer 110 determines the drying time on the basis of the amount of liquid discharged per unit area smaller than the entire image corresponding to image data, so that the image is prevented from being blurred and the drying time is reduced as much as possible.

FIG. 11 is a diagram illustrating a state of calculation of a maximum amount of liquid discharged per unit area in a printed pattern obtained by printing a white image and an ABC image in an overlapping manner. In the printed pattern shown in FIG. 11, only one character “A” of the ABC image is printed on the white image. In this case, it is unnecessary to calculate all of amounts of liquid discharged to respective unit areas constituting image data of the white image. An amount of liquid discharged to each of the unit areas, indicated by hatching in the figure, where the ABC image is printed so as to overlap the white image may be calculated. In addition the amounts of liquid discharged to the unit areas where the ABC image overlaps the white image, an amount of liquid discharged to each of unit areas surrounding the above unit areas may be calculated. Consequently, the time required to calculate an amount of liquid discharged per unit area can be reduced and the time required to determine the print mode can also be reduced. For example, in a case where the amount of liquid discharged to an area where images are printed so as not to be superimposed is large but the amount of liquid discharged to an area where the images are printed in a superimposed manner is small, the drying time can be set short. In this case, assuming that a first image is printed and a second image is then printed so as to overlap the first image, even when a portion, which the second image does not overlap, of the first printed image is not dried upon printing the second image, the images printed overlappingly are not blurred. Accordingly, there is no problem.

### SECOND EXAMPLE OF SELECTING PRINT MODE

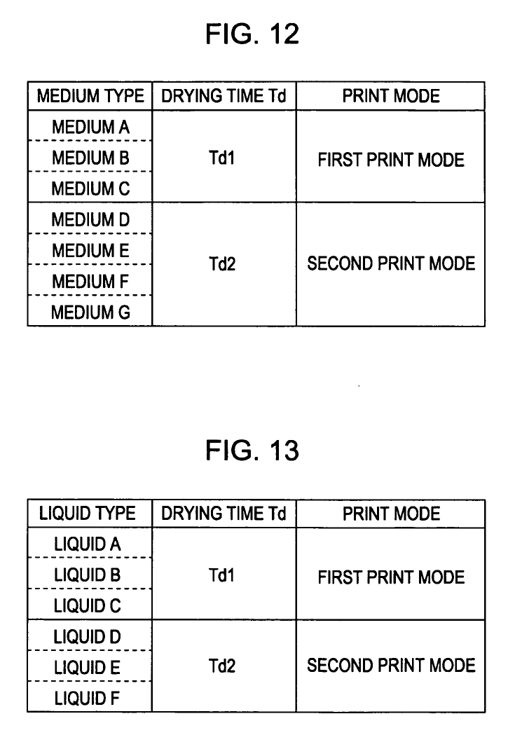

FIG. 12 is a table for determining the drying time Td and the print mode on the basis of the type of medium on which printed patterns are to be produced. Media are classified into two types, one type of medium being easily absorbing liquid (ink) landed on the medium, the other type of medium being hardly absorbing liquid landed on the medium. As for a medium that hardly absorbs liquid, drying time is long because the liquid does not penetrate the medium. In other words, the type of medium affects the drying time Td. In the second example, therefore, the computer 110 sets the drying time Td on the basis of “the type of medium” and selects the print mode. In the embodiment, it is assumed that the printer 1 can print image on seven types of media (media A to G). The media include, for example, the above-described transparent film, wood-free paper, art paper, mirror coated paper, foil paper, kraft paper, Japanese paper, synthetic paper, and fabric.

The media A to G on which the printer 1 can perform printing are classified into two groups. One group includes the media A to C that have relatively low liquid absorbability and the other group includes the media D to G that have relatively high liquid absorbability. Producing printed patterns on any of the media A to C requires drying time Td1 that is greater than the transporting time Tc in the first print mode. Consequently, the print processing time of the first print mode is less than that of the second print mode (FIG. 8C). On the other hand, producing printed patterns on any of the media D to G requires drying time Td2 that is less than the transporting time Tc in the first print mode. Consequently, the print processing time of the second print mode is less than that of the first print mode (FIG. 8A). In other words, the drying time Td is determined on the basis of the type of medium.

In the second example, the memory of the computer 110 is allowed to store the table shown in FIG. 12. When receiving image data, the computer 110 determines whether images are printed in a superimposed manner to produce printed patterns in a manner similar to the above-described first example. When images are printed in a superimposed manner to produce printed patterns, the computer 110 detects the type of medium designated by a user from image data and verifies the medium type with the table of FIG. 12. For example, when the medium type indicated by the image data is “medium B”, the computer 110 sets the drying time Td1 as the drying time Td and selects the first print mode. When the medium type indicated by the image data is “medium F”, the computer 110 sets the drying time Td2 as the drying time Td and selects the second print mode. After that, the computer 110 generates printing data for printing in the selected print mode.

As described above, the time required to dry first printed images varies depending on the type of medium. Therefore, the drying time Td is set on the basis of the medium type and the print mode is then selected, so that print processing time can be reduced without blurring the images. In the table of FIG. 12, the two drying times Td1 and Td2 are set according to the medium types. The setting manner is not limited to this example. Many drying times Td may be set and the print mode may be selected on the basis of any of the drying times Td.

### THIRD EXAMPLE OF SELECTING PRINT MODE

FIG. 13 is a table for determining the drying time Td and the print mode on the basis of the type of liquid for producing printed patterns. Liquids are classified into two types, one type of liquid easily penetrating media, the other type of liquid hardly penetrating media. The liquid easily penetrating media is easy to dry. Accordingly, the time required to dry such liquid is short. On the other hand, the liquid hardly penetrating media is difficult to dry. Therefore, the time required to dry such liquid is long. The liquid easily penetrating media is, for example, liquid (ink) containing a penetrating agent. In the third example, since the type of liquid affects the drying time Td, the computer 110 sets the drying time Td on the basis of “the type of liquid” and selects the print mode. In the embodiment, it is assumed that the printer 1 forms images using, for example, any of six liquids (liquids A to F). The liquids include, for example, dye ink and pigmented ink for printing images, UV ink to be irradiated with UV rays, and a fixing agent.

The printer 1 classifies the liquids A to F available for printing into two groups. One group includes the liquids A to C that relatively hardly penetrate media. The other group includes the liquids D to F that relatively easily penetrate media. Producing printed patterns using any of the liquids A to C requires the drying time Td1 that is greater than the transporting time Tc in the first print mode. Thus, the print processing time of the first print mode is less than that of the second print mode (FIG. 8C). On the other hand, producing printed patterns using any of the liquids D to F requires the drying time Td2 that is less than the transporting time Tc in the first print mode. Thus, the print processing time of the second print mode is less than that of the first print mode (FIG. 8A). In other words, the drying time Td is determined on the basis of “the type of liquid used for first printed images”.

In the third example, the memory of the computer 110 is allowed to store the table as shown in FIG. 13. When receiving image data, the computer 110 determines whether images are printed in a superimposed manner to produce printed patterns in a manner similar to the above-described first example. When images are printed in a superimposed manner to produce printed patterns, the computer 110 detects the type of liquid for first printed images and verifies the liquid type with the table of FIG. 13. For example, when the liquid type indicated by the image data is “liquid A”, the computer 110 sets the drying time Td1 as the drying time Td and selects the first print mode. When the liquid type indicated by the image data is “liquid D”, the computer 110 sets the drying time Td2 as the drying time Td and selects the second print mode. After that, the computer 110 generates printing data for printing in the selected print mode.

As described above, the time required to dry first printed images varies depending on the type of liquid. Therefore, the drying time Td is set according to the liquid type and the print mode is selected, so that the print processing time can be reduced without blurring the images. Although the two drying times Td1 and Td2 are set according to the liquids in the table of FIG. 13, the setting manner is not limited to this case. Many drying times Td may be set and the print mode may be selected on the basis of any of the drying times Td.

### FOURTH EXAMPLE OF SETTING PRINT MODE

A fourth example of setting the print mode is an example of selection among the print modes of the printer 1 including the hot platen 41, serving as a medium dry unit located in the printing zone as shown in FIG. 2. The hot platen 41 supports the medium and includes the heater (dry unit) therein. The hot platen 41 heats the medium in the printing zone to accelerate drying of printed images in the printing zone. It is assumed that the heater included in the hot platen 41 can be turned on or off during turn-on of the printer 1 and, when the heater is not needed, the heater can be turned off during printing. For example, when printed patterns are produced such that images are printed so as not to be superimposed, alternatively, when images easy to dry are printed, the heater in the hot platen 41 is turned off, thus achieving power saving.

In the fourth example, the computer 110 makes a determination, on the basis of at least one of the printing conditions affecting the drying time Td, i.e., “the amount of liquid discharged”, “the type of medium”, and “the type of liquid”, as described in the first to third examples, as to whether or not to use the hot platen 41. When the hot platen 41 is used, the drying time is reduced, so that the print processing time is reduced by the reduced amount. Accordingly, for example, when the user specifies high-speed print mode, the hot platen 41 may be used. Since the hot platen 41 is not available for a heat-sensitive medium, whether or not to use the hot platen 41 may be determined according to the type of medium. In other words, whether or not to use the hot platen 41 may be determined on the basis of whether the hot platen 41 can be used.

Using the hot platen 41 results in a reduction in the drying time Td. Accordingly, when the hot platen 41 is used, the computer 110 sets the drying time Td to be less than the transporting time Tc in the first print mode. Consequently, the computer 110 determines that the print processing time of the second print mode is less than that of the first print mode (FIG. 8A) and selects the second print mode. Whereas, when the hot platen 41 is not used, the computer 110 sets the drying time Td to be greater than the transporting time Tc in the first print mode. Consequently, the computer 110 determines that the print processing time of the first print mode is less than that of the second print mode (FIG. 8C) and then selects the first print mode.

As described above, the drying time Td is set on the basis of determination as to whether or not to use the hot platen 41 (i.e., whether or not to use the heater, serving as the dry unit) and then selects the print mode, so that the print processing time can be reduced without blurring the images. The unit for drying a medium in the printing zone as described is not limited to a member that dries the medium using heat generated by a heater. In other words, the drying time Td is determined on the basis of “whether or not to use the unit for drying a medium in the printing zone”.

### FIFTH EXAMPLE OF SELECTING PRINT MODE

In each of the first to fourth examples, the print mode is selected on the basis of one printing condition affecting the drying time Td. The selecting manner is not limited to the above-described manner. The computer 110 may set the drying time Td on the basis of a plurality of printing conditions among those described in the first to fourth examples, namely, “the amount of liquid discharged”, “the type of medium”, “the type of liquid”, and “whether or not to use the hot platen 41” and then select the print mode.

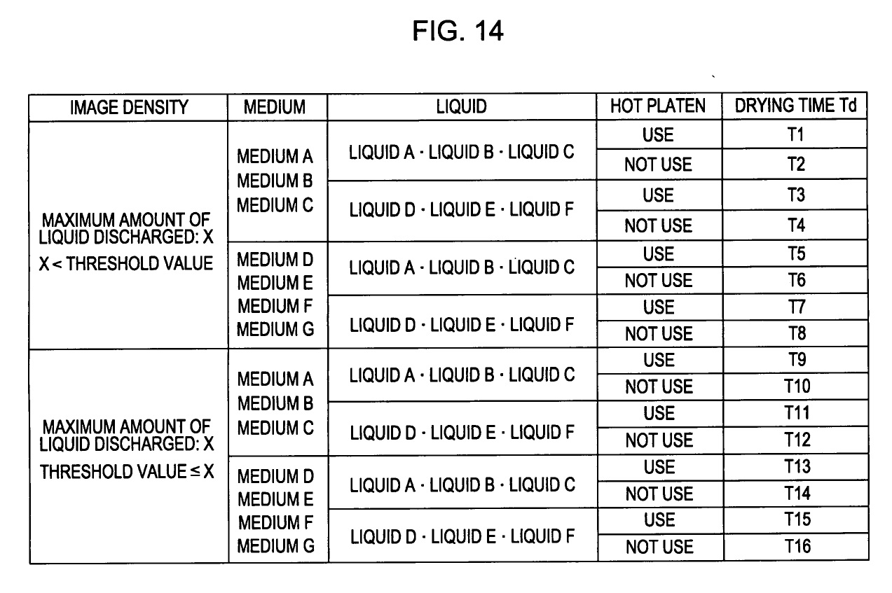

FIG. 14 is a table for determining the drying time Td and the print mode on the basis of all of the above-described four printing conditions related to the drying time Td. When receiving image data, the computer 110 calculates a maximum amount X of liquid discharged per unit area of images to be first printed. In addition, the computer 110 determines whether or not to use the hot platen 41. After that, the computer 110 verifies the calculated maximum amount X of liquid discharged, the type of medium and the type of liquid indicated in the image data, and whether or not to use the hot platen 41 with the table of FIG. 14, thus determining the drying time Td (any one of T1 to T16). A threshold value can be set with respect to the maximum amount of liquid discharged per unit area. Preferably, so long as the maximum amount X of liquid discharged is less than the threshold value, the drying time Td becomes shorter, and when the maximum amount X of liquid discharged is equal to or greater than the threshold value, the drying time Td becomes longer.

After the drying time Td is determined, the computer 110 compares the transporting time Tc in the first print mode with the drying time Td to select the print mode. When the drying time Td is greater than the transporting time Tc in the first print mode, the first print mode is selected. When the drying time Td is less than the transporting time Tc in the first print mode, the second print mode is selected. Thus, the print processing time can be reduced.

In this example, the printing conditions described in the first to fourth examples, i.e., “the amount of liquid discharged”, “the type of medium”, “the type of liquid”, and “whether or not to use the hot platen 41” are the printing conditions affecting the drying time. The printing conditions are not limited to those conditions. The drying time Td and the print mode may be determined on the basis of other printing conditions that affect the drying time Td.

### First Modification (Other Printed Patterns)

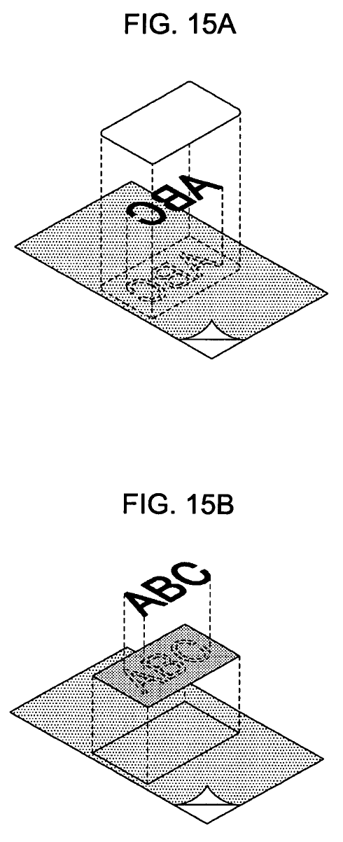

FIGS. 15A and 15B are diagrams illustrating other printed patterns each obtained by printing a plurality of images in a superimposed manner. Although the printed patterns each including a white image and an ABC image superimposed on the white image have been described in the above embodiment, the printed patterns are not limited. For example, a printed pattern may be obtained by printing a white image and an ABC image in the different order as shown in FIG. 15A. As for the printed pattern shown in FIG. 15A, when a peelable member (on which an image is not printed) constituting a medium is removed from a label member and the adhesive surface of the label member is bonded to a window on the inside of a room, characters “ABC” can be seen through the window and the label member on the outside of the room. Therefore, a mirror image of the ABC image is printed. In addition, a printed pattern obtained by printing the ABC image on an image other than the white image may be produced as shown in FIG. 15B. For example, an image to be first printed on a medium may be a rectangular underlying image formed by applying a fixing agent that accelerates absorption of liquid to the medium.

Each of the printed patterns in FIGS. 15A and 15B is obtained by printing two images in a superimposed manner as in the case of the printed pattern in FIG. 4. Accordingly, the transporting times Tc and tc during producing the printed patterns in the respective print modes are the same as those described above in the foregoing embodiment independently of the printed patterns. Since six images are printed during one printing operation, the printing time of one printing operation in each print mode is also the same as that described above in the foregoing embodiment independently of the printed patterns. Accordingly, the print mode for producing the printed patterns in FIG. 4, 15A, or 15B differs depending on the drying time Td for first printed images.

For example, it is assumed that the computer 110 determines the print mode on the basis of “the maximum amount, of liquid discharged per unit area” as described in the foregoing first example. So long as image data indicates the printed pattern shown in FIG. 4, the drying time Td and the print mode are determined on the basis of the maximum amount of liquid discharged per unit area in image data of the white image. On the other hand, when image data indicates the printed pattern in FIG. 15A, the drying time Td and the print mode are determined on the basis of the maximum amount of liquid discharged per unit area in image data of the ABC image. It is assumed that the white image is a filled-in image and the maximum amount of liquid discharged per unit area of the white image is larger than that of the ABC image. As for the printed pattern in FIG. 4, therefore, the drying time Td is greater than the transporting time Tc in the first print mode. The first print mode is selected (FIG. 8C). As for the printed pattern in FIG. 15A, the drying time Td is less than the transporting time Tc in the first print mode. The second print mode is selected (FIG. 8A).

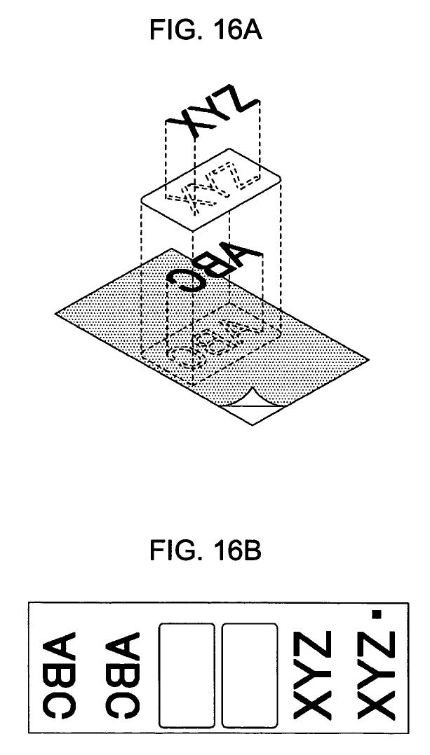

FIG. 16A is a diagram illustrating a printed pattern obtained by printing three images in a superimposed manner. FIG. 16B is a diagram illustrating printing data for printing the three images in a superimposed manner in the second print mode. Although the above-described printed patterns each obtained by printing two different images in a superimposed manner have been described, the printed patterns are not limited. For example, a printed pattern obtained by printing three different images in a superimposed manner as shown in FIG. 16A may be produced. The printed pattern is obtained by printing a mirror image of the ABC image on a medium, printing the white image on the mirror image, and printing a character image “XYZ” (hereinafter, “XYZ image”) on the white image. Assuming that the printed pattern including the white image between the mirror image of the ABC image and the XYZ image is bonded on a window, when the characters “ABC” are seen on the outside of a room, the XYZ image is not seen. When the characters “XYZ” are seen on the inside of the room, the ABC image is not seen.

To produce printed patterns, each obtained by printing the three different images in a superimposed manner, in the first print mode, six printed patterns are formed each time three printing operations are finished. Two waiting operations are needed for intervals between the three printing operations. On the other hand, to produce the printed patterns in the second print mode, printing is repeatedly performed on the basis of the printing data illustrated in FIG. 16B. Accordingly, the amount of the medium transported in one transporting operation corresponds to the length of a portion, including two printed patterns, of the medium. Therefore, two printed patterns are formed every printing operation. When three different images are printed in a superimposed manner to produce printed patterns as described above, the print mode with shorter print processing time is changed depending on the relationship among the drying time for first printed images and the transporting times in a manner similar to the case (FIGS. 8A to 8C) where two different images are printed in a superimposed manner to produce printed patterns. Even when three different images are printed in a superimposed manner, therefore, the computer 110 may be allowed to select the print mode with shorter print processing time on the basis of the relationship among the drying time and the transporting times, namely, at least one printing condition. Thus, the print processing time can be reduced without blurring the images. In the case where three different images are printed in a superimposed manner as described above, the time required to dry first printed images may be set so as to differ from the time required to dry second printed images. Preferably, the computer 110 selects the print mode with shorter print processing time in consideration of the above-described difference.

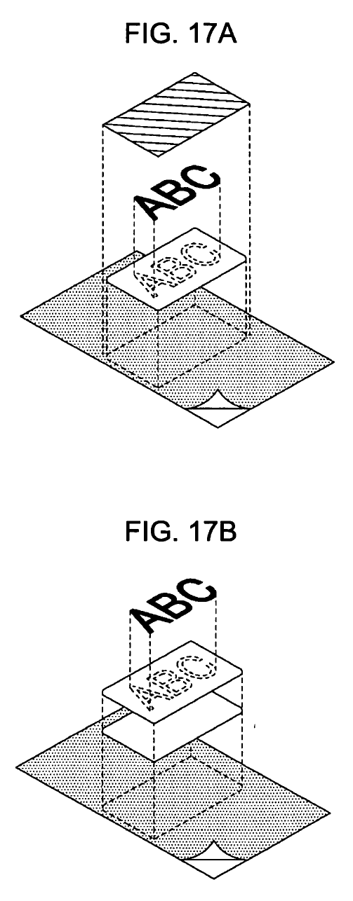

FIGS. 17A and 17B are diagrams illustrating other printed patterns each obtained by printing three different images in a superimposed manner. A printed pattern obtained by printing three different images in a superimposed manner is not limited to that shown in FIG. 16A. For example, as shown in FIG. 17A, a printed pattern may be produced by printing a white image on a medium, printing an ABC image on the white image, and applying a coating agent on the images. Such a printed pattern has an effect of improving the luster of the white and ABC images and an effect of improving the water resistance of the images. In addition, as shown in FIG. 17B, a printed pattern may be produced by printing a first white image, printing a second white image on the first one, and printing an ABC image on the second white. Thus, the white images for background can be printed thickly, so that the characters “ABC” can be seen clearly. In the case where such printed patterns are produced, the computer 110 may set drying time on the basis of first printed images and select the print mode with shorter print processing time on the basis of the set drying time.

Second Modification (Comparison between First and Second Images)

In the above-described embodiment, the computer 110 selects the print mode with shorter print processing time on the basis of the relationship among the drying time for first printed images (white images) and the transporting times. According to a second modification, the drying time for first printed images is compared to that for second printed images.

For example, as for a printed pattern obtained by printing a white image and an ABC image in a superimposed manner, when a medium may be located adjacent to the white image as shown in FIG. 4, or the ABC image as shown in FIG. 15A, the drying time for the white image is compared to that for the ABC image. To set the drying times for the two images, comparison may be performed on the basis of “the maximum amount of liquid discharged per unit area” as described in the first example, alternatively, on the basis of “the type of liquid” as described in the third example. For instance, when the drying time for the ABC image is less than that of the white image as a filled-in image, the ABC image may be printed first as shown in FIG. 15A. When an image for which drying time is shorter is printed first, the drying time Td of the first printed image can be reduced, thus reducing the total print processing time.

Similarly, as for a printed pattern obtained by printing an XYZ image and an ABC image such that a white image is interposed therebetween on a medium, as shown in FIG. 16A, when the medium may be located adjacent to any of the ABC image and the XYZ image, drying time for the ABC image can be compared to that for the XYZ image. The image for which the drying time is shorter is printed first, so that the total print processing time can be further reduced.

### Other Embodiments

Although the above-described embodiment has been described with respect to the printer, it is needless to say that aspects of the invention include a printing apparatus, a recording apparatus, a liquid discharging apparatus, a printing method, a recording method, a liquid discharging method, a printing system, a recording system, a computer system, a program, a storage medium that stores the program, and a printed pattern producing method.

The printer has been described in the foregoing embodiment. The foregoing embodiment is intended for easy understanding of the invention and is not intended for limited interpretation of the invention. It should be understood that many modifications and variations of the invention are possible without departing from the spirit and scope of the invention and the invention also includes equivalents thereof. In particular, the invention includes the following embodiments.

### Method for Selecting Print Mode

A printing condition for selecting a printing method is not limited to the above-described drying time for an image. For example, a memory capacity required to store printing data for the first print mode is greater than that for the second print mode. Therefore, the print mode may be selected in such a manner that when the amount of image data to be printed is greater than a predetermined amount, printing is performed in the second print mode, and when the amount of image data to be printed is less than the predetermined amount, printing is performed in the first print mode. In other words, the print mode may be selected on the basis of various printing conditions.

The printing apparatus may select the print mode in response to a user input. For example, it is assumed that the user selects a power saving mode. In the first print mode, the medium has to be dried in the areas A to F in FIG. 5 by the medium dry unit (hot platen) in the printing zone or the dry mechanism located downstream of the printing zone. On the other hand, in the second print mode, the medium can be dried in the areas A to C. When the second print mode is selected, therefore, printing can be performed with lower power than the first print mode. As described above, the print mode may be selected on the basis of a user input as a printing condition.

### Printer

In the above-described printer, printing can be performed in the entire printing zone by one movement of the carriage in the transporting direction. The printer is not limited to such a type. For example, a printer in which a carriage is two-dimensionally moved in a printing zone to perform printing in the printing zone may be used. In such a printer, although a printing operation takes longer time than the above-described printer, the size of a head can be reduced.

### Images

In the foregoing embodiment, a background image is printed using white ink on a medium, such as a transparent film, and a character image (ABC) is printed on the background image. The background image is not limited to such a white image. In addition, although the shape of the background image or a base image, such as an underlying image or a coating image, is rectangular in the foregoing embodiment, the shape is not limited to a rectangle. Another shape may be used. Furthermore, although the underlying image or coating image is formed for processing of improving the ink absorbability, luster, and/or water resistance of the medium, such an image for the processing is not limited to the above-described underlying image or coating image. For example, the processing image may be an adhesive-layer image for formation of an adhesive layer or a concealing-layer image for formation of a concealing layer for a scratch card (e.g., a card in which an image is allowed to appear when a silver concealing layer is removed using a coin).

What is claimed is:

1. A method for producing a plurality of printed patterns on a continuous medium, comprising:
selecting either of a first print mode and a second print mode on the basis of a printing condition;
when the first print mode is selected, alternately repeating an operation of printing a plurality of first images on the continuous medium located in a printing zone and printing a plurality of second images on the first images after a lapse of waiting time and an operation of transporting the continuous medium; and
when the second print mode is selected, alternately repeating an operation of printing the first images on the continuous medium located in a first area of the printing zone and printing the second images on the continuous medium located in a second area, downstream of the first area in the transporting direction in which the medium is transported, of the printing zone and an operation of transporting the first images printed in the first area to the second area so that the second images are printed on the first images.

2. The method according to claim 1, wherein in the selecting, the print mode with shorter print processing time during which a predetermined number of printed patterns are produced is selected.

3. The method according to claim 1, wherein in the selecting, the waiting time is compared to the time required for the transporting operation to select the print mode with shorter print processing time during which a predetermined number of printed patterns are produced.

4. The method according to claim 1, wherein the waiting time is determined on the basis of a maximum amount of liquid discharged per unit area of the first images.

5. The method according to claim 1, wherein the waiting time is determined on the basis of the type of continuous medium.

6. The method according to claim 1, wherein the waiting time is determined on the basis of the type of liquid used for printing the first images.

7. The method according to claim 1, wherein the waiting time is determined on the basis of whether or not to use a drying unit that dries the printed patterns while supporting the continuous medium in the printing zone.

8. A printing apparatus comprising:
a head that discharges liquid to a continuous medium;
a transporting mechanism that transports the continuous medium to a printing zone; and
a control unit that controls producing of a plurality of printed patterns on the continuous medium, wherein
the control unit selects either of a first print mode and a second print mode on the basis of a printing condition,
in the first print mode, an operation of printing a plurality of first images on the continuous medium located in the printing zone and printing a plurality of second images on the first images after a lapse of waiting time and an operation of transporting the continuous medium being alternately repeated,
in the second print mode, an operation of printing the first images on the continuous medium located in a first area of the printing zone and printing the second images on the continuous medium located in a second area, downstream of the first area in the transporting direction in which the medium is transported, of the printing zone and an operation of transporting the first images printed in the first area to the second area so that the second images are printed on the first images being alternately repeated.

9. A method for printing, comprising:
transporting a continuous medium to a printing zone; and
controlling producing of a plurality of printed patterns on the continuous medium, wherein
in the controlling, either of a first print mode and a second print mode is selected on the basis of a printing condition,
in the first print mode, an operation of printing a plurality of first images on the continuous medium located in the printing zone and printing a plurality of second images on the first images after a lapse of waiting time and an operation of transporting the continuous medium being alternately repeated,
in the second print mode, an operation of printing the first images on the continuous medium located in a first area of the printing zone and printing the second images on the continuous medium located in a second area, downstream of the first area in the transporting direction in which the medium is transported, of the printing zone and an operation of transporting the first images printed in the first area to the second area so that the second images are printed on the first images being alternately repeated.
